(19) United States
(12) Patent Application Publication
(10) Pub. No.: US 2008/0262639 A1
(43) Pub. Date: Oct. 23, 2008

(54) Method for operation of a functionally modular automation device with a control loop

(75) Inventor: Frank Marks, Dusseldorf (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/081,691

(22) Filed: Apr. 18, 2008

(30) Foreign Application Priority Data
Apr. 23, 2007 (DE) 10 2007 019 050.8

(51) Int. Cl. G05B 11/01

(52) U.S. Cl. 700/14; 700/12

(57) ABSTRACT

The disclosure relates to a method for operation of a functionally modular automation device having a control loop, which device is connected to a feed line whose power is limited. It is proposed that the criterion for activation or deactivation of functional modules of the device is derived from the control error (x_{w}). The functionally modular automation device having a control loop is also disclosed.

### RELATED APPLICATION

This application claims priority under 35 U.S.C. §119 to German Patent Application No. 10 2007 019 050.8 filed in Germany on Apr. 23, 2007, the entire content of which is hereby incorporated by reference in its entirety.

### TECHNICAL FIELD

The disclosure relates to a method for operation of a functionally modular automation device having a control loop, which device is connected to a feed line whose power is limited.

### BACKGROUND INFORMATION

In particular, but not exclusively, said devices include electrical equipment which is arranged close to the process and locally in the field area and is fed from a central device in the console area.

Known equipment is connected by means of a connecting line to a central device, with each equipment item being supplied via the connecting line with electrical power for its operation and possibly interchanging data with the central device. The connection of the equipment in the explosion-hazard area of a process installation is subject to particular requirements for the electrical equipment, in order to preclude any possible explosion accident. During the installation and commissioning of electrical devices and equipment as well as during maintenance work on electrical devices and equipment in process installations which are in an explosion-hazard atmosphere by virtue of their purpose, compliance with the relevant legal regulations is essential, such as “Verordnung über elektrische Anlagen in explosionsgefährdeten Bereichen—ElexV”[“Order on electrical installations in explosion-hazard areas”] and the European standards for explosion protection EN 50 014 et seq.

On the basis of these legal regulations, electrical diodes can be disconnected and connected, grounded and short-circuited without conditions only in the case of intrinsically safe circuits, which are subject to the rules of EN 50 020 as “intrinsically safe”ignition degree of protection.

The power of intrinsically safe circuits is therefore limited. In this case the feed power that is provided to an ever greater extent fails to meet the more stringent requirements for the equipment. The increasing functional scope of the equipment can no longer be maintained from the feed power that is provided during long-term continuous operation.

The equipment may be the regulative part of a control loop or may comprise a control loop whose set-value preset is obtained from the central device. In this case, it is possible to provide for the set-value preset to be transmitted to the equipment via a feed line.

It is known for fluctuations in the power demand to be compensated for by means of high-capacity energy stores, for example, so-called goldcaps. This procedure is successful, however, only when just temporary demand peaks have to be bridged above a nominally available average demand. As soon as the average demand exceeds the nominally provided feed power, maintenance on full operation is no longer ensured.

It is known from U.S. Pat. No. 5,305,952 for the functional scope of an electrical equipment item to be restricted or extended as a function of a manual action by the user. However, this is unacceptable for automation devices.

It is known, from EP 1 704 435 A1, for the power consumption to be reduced by intermittent operation of the load. Furthermore, this document mentions periodically alternate activation of one load from a plurality of identical loads. This procedure may have unpredictable consequences in non-periodic processes of changing volatility.

U.S. Pat. No. 5,375,247 discloses an inactive load being switched off with a delay.

EP 1 684 467 A1 discloses an inactive load being reactivated by a predefined number of calls of a predefined call type.

### SUMMARY

A method for operation of a functionally modular automation device is disclosed, which causes the power consumption to be reduced for non-periodic processes of changing volatility.

A method for operation of a functionally modular automation device is disclosed having a control loop, which device is connected to a feed line whose power is limited, wherein the criterion for activation or deactivation of functional modules of the device is derived from the control error (x_{w}).

A functionally modular automation device is disclosed, which device is connected to a feed line whose power is limited. The device includes functional modules of the device capable of activation or deactivation based on a criterion; and a control loop. The criterion for activation or deactivation of functional modules of the device is derived from a control error.

### BRIEF DESCRIPTION OF THE DRAWINGS

The disclosure will be explained in more detail in the following text using the example of an actuating drive which is operated with a pressure medium. The drawings which are required for this purpose show:

FIG. 1 shows an outline illustration of an exemplary actuating drive, which is operated with a pressure medium with a process valve,

FIG. 2 shows an outline illustration of an exemplary position regulator.

### DETAILED DESCRIPTION

The disclosure is based on electrical equipment which has at least the regulative part of a control loop and is of functionally modular design. In this case, the expression functionally modular design means an equipment whose functional scope comprises a plurality of individual functions, which can each be activated and deactivated in their own right. In this case, the power consumption of deactivated equipment is less than its power consumption in the active state.

According to the disclosure, the criterion for activation or deactivation of functional modules of the equipment is derived from the control error.

When the regulator is in the steady state, the idealized control error is equal to zero. In this state, the equipment is relatively at rest, with this being characterized by maintenance of the instantaneous operating point, and in which the dynamically applied individual functions can be deactivated if they are not used at that time.

As soon as a control error other than zero results from a change in the set-value preset or from an undesired change in the actual value, the equipment leaves the state of relative rest. For this purpose, the deactivated individual functions required to reproduce the steady state are activated and are operated in accordance with the regulations.

The criterion of the control error as a characteristic fact for the handling requirement is advantageously independent of its cause. Both any operation-dependent change in the set-value preset and any undesirable change in the actual value result in a change in the control error. It is therefore sufficient to monitor one criterion in order to detect two different discrepancies from the desired state.

Furthermore, the duration of operation of the equipment can be matched to the actual need. In this case, the regulation process at any given time leads to start-up and, after this has been done, also to the deactivation of the corresponding units.

Furthermore, the control error can be an available variable, which is available in any case and is subject to continuous monitoring. The effort to provide the criterion is accordingly very low. Furthermore, the material complexity is very low since the method can be implemented in software for the latest regulators, which are generally based on microcontrollers.

This method is particularly suitable for devices with continuous regulators for processes with little dynamic change or with two-point regulators.

Furthermore, this method can be used as a component in a higher-level power management system.

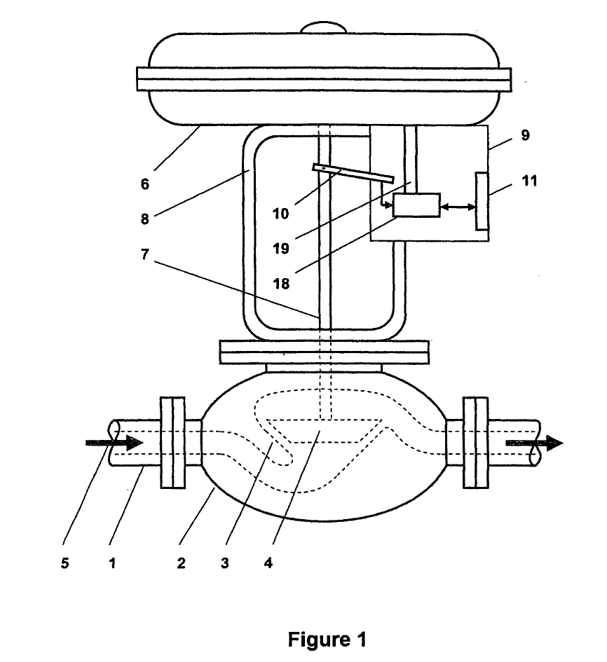

FIG. 1 shows a pipeline 1, which is indicated in a fragmentary form, of a process installation which is not illustrated in any more detail, in which a process valve 2 is installed. In its interior, the process valve 2 has a closure body 4, which interacts with a valve seat 3, in order to control the flow rate of the process medium 5. The closure body 4 is operated linearly by an actuating drive 6 via a valve rod 7. The actuating drive 6 is connected to the process valve 2 via a yoke 8. A position regulator 9 is fitted to the yoke 8. The movement of the valve rod 7 is signaled to the position regulator 9 via a position sensor 10. The movement detected is compared in a control unit 18 with the set value, which is supplied via a communication interface 11, and the actuating drive 6 is driven as a function of the determined control error. The control unit 18 for the position regulator 9 has an I/P converter for conversion of an electrical control error to an adequate control pressure. The I/P converter for the control unit 18 is connected to the actuating drive 6 via a pressure-medium supply 19.

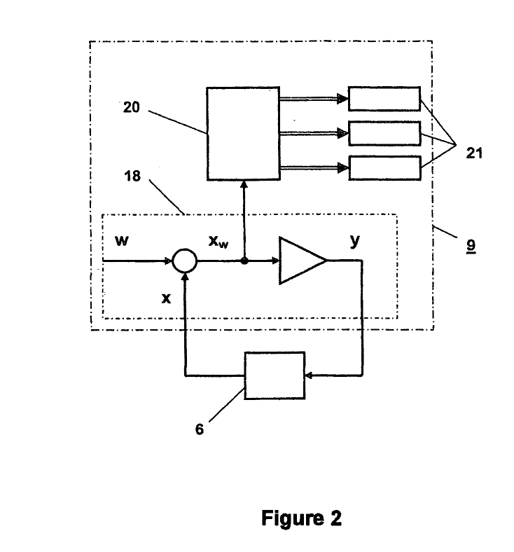

FIG. 2 shows an outline illustration of the structure of the position regulator 9, to the extent that it is affected by the disclosure. The position regulator 9 has a control unit 18, which physically comprises an adder and a control amplifier. The adder determines the control error x_{w} from the reference variable w which represents the set value and the controlled variable x, which represents the actual value and the control error x_{w} is supplied to the input of the control amplifier. The manipulated variable y is emitted at the output of the control amplifier to the actuating drive 6, the source of the controlled variable x.

The control unit 18 can be in the form of a microcontroller, in which the controlled error x_{w} and the manipulated variable y are calculated using a predetermined algorithm. For this purpose, the controlled variable x is tapped off at the position sensor 10 and is quantified by an analog/digital converter which is not illustrated.

The position regulator 9 also has a switching means 20 for quantitative assessment of the control error x_{w} and for activation of functional modules 21 that are required and for deactivation of functional modules 21 which are temporarily not required. In particular, but not exclusively, these functional modules 21 which can be activated include the analog/digital converter for the position sensor 10. Analog/digital converters such as these are, as a function of the quantization method provided, among the loads which form the major loads on the energy budget of the automation device with a feed whose power is limited.

However, a requirement to convert an analog position variable to a digital equivalent exists only for a position change. As long as the actuating drive 6 is at rest, the position does not change and the final position variable is still valid. The analog/digital converter is deactivated during this rest phase.

When a control error x_{w} other than zero occurs, the analog/digital converter is reactivated in order to convert the position changes at that time.

Furthermore, the functional modules 21 which can be temporarily deactivated include diagnosis means, which are directed at process-dynamic data. When the actuating drive 6 is in the rest phase, no process-dynamic data occurs, so that the diagnosis means can be deactivated without loss of information. On leaving the rest phase, the diagnosis means is reactivated.

In a further refinement of the disclosure, it is possible to provide for the functional modules 21 to have the capability to be deactivated with a time delay when the control error x_{w} reaches zero. This avoids immediately successive activation and deactivation processes.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

### LIST OF REFERENCE SYMBOLS

1 Pipeline
2 Process valve
3 Valve seat
4 Closure body
5 Process medium
6 Actuating drive
7 Valve rod
8 Yoke
9 Position regulator
10 Position sensor
11 Communication interface
18 Control unit
19 Pressure-medium supply
20 Switching means
21 Functional module

What is claimed is:

1. A method for operation of a functionally modular automation device having a control loop, which device is connected to a feed line whose power is limited,
wherein the criterion for activation or deactivation of functional modules of the device is derived from a control error.

2. The method as claimed in claim,
wherein functional modules are activated if the control error is not zero.

3. The method as claimed in claim 1,
wherein functional modules are deactivated with a time delay when the control error is zero.

4. The method as claimed in claim 2,
wherein functional modules are deactivated with a time delay when the control error is zero.

5. A functionally modular automation device, which device is connected to a feed line whose power is limited, the device comprising:
functional modules of the device capable of activation or deactivation based on a criterion; and
a control loop, wherein the criterion for activation or deactivation of functional modules of the device is derived from a control error.

6. The automation device as claimed in claim 5, wherein functional modules are activated if the control error is not zero.

7. The automation device as claimed in claim 5, wherein functional modules are deactivated with a time delay when the control error is zero.

8. The automation device as claimed in claim 6, wherein functional modules are deactivated with a time delay when the control error is zero.
